(19) United States
(12) Patent Application Publication
(10) Pub. No.: US 2013/0261591 A1
(43) Pub. Date: Oct. 3, 2013

(54) VIAL DEVICE AND METHODS

(71) Applicants: C. Garyen Denning, Lexington, KY (US); Theodore J. Mosler, Raleigh, NC (US); Jessie Delgado, Durham, NC (US)

(72) Inventors: C. Garyen Denning, Lexington, KY (US); Theodore J. Mosler, Raleigh, NC (US); Jessie Delgado, Durham, NC (US)

(21) Appl. No.: 13/852,808

(22) Filed: Mar. 28, 2013

Related U.S. Application Data
(60) Provisional application No. 61/616,656, filed on Mar. 28, 2012.

(51) Int. Cl. A61J 1/14

(52) U.S. Cl. CPC A61J 1/1406
USPC 604/403

(57) ABSTRACT

Disclosed are embodiments of a vial device and related systems that can include a cartridge that can have a proximal end and a distal end, where the cartridge can include a housing that defines a fluid chamber. Embodiments of the vial device can include a first stopper, where the first stopper can be positioned at about the proximal end of the cartridge, and a second stopper, where the second stopper can be movable relative to the cartridge. Embodiments of the vial device can include an outer housing, where the cartridge can be configured to seat within the outer housing.

### REFERENCE TO RELATED APPLICATION

The present application claims priority of U.S. provisional application Ser. No. 61/616,656, filed Mar. 28, 2012, and hereby incorporates the same application herein by reference in its entirety.

### TECHNICAL FIELD

This application relates generally to vial devices for fluid storage and delivery, and more particularly to vial devices that can be used to store and deliver medicinal fluids.

### BACKGROUND

It is a common practice to store medicines or other medically related fluids in vials. In some instances, the medicines or fluids so stored are therapeutic if injected into the bloodstream, but harmful if inhaled or if contacted by exposed skin. During use, a medical practitioner generally draws the medication or controlled substance from the vial by inserting the needle of a standard syringe therein and withdrawing the contents.

### BRIEF DESCRIPTION OF THE DRAWINGS

It is believed that certain embodiments will be better understood from the following description taken in conjunction with the accompanying drawings in which:

FIG. 1 is an exploded view of a vial device according to one embodiment, depicting a cartridge and an associated outer housing;

FIG. 2 is a side elevational view of the vial device shown in FIG. 2 according to one embodiment;

FIG. 3 is a longitudinal cross-sectional view of the vial device shown in FIG. 2, taken along reference line 3-3, according to one embodiment;

FIG. 4 is a perspective view of the outer housing of FIG. 1, according to one embodiment;

FIG. 5 is an enlarged view of the encircled portion 5 of FIG. 4, depicting a flange and vents on the outer housing according to one embodiment;

FIG. 6 is a side elevational view of the cartridge of FIG. 1 according to one embodiment;

FIG. 7 is a longitudinal cross-sectional view of the cartridge shown in FIG. 6, taken along line 7-7, according to one embodiment;

FIG. 8 is a longitudinal cross-sectional view taken along reference line 3-3 of FIG. 2, shown with the cartridge removed according to one embodiment;

FIGS. 9A-9C are longitudinal cross-sectional views of a vial device depicting the proximal translation of a proximal stopper as fluid is withdrawn from the fluid chamber according to one embodiment;

FIG. 10 is a perspective view of a vial device having an amber outer housing according to an alternate embodiment;

FIG. 11A is a perspective view of an amber vial device and a perspective view of a clear vial device according to one embodiment; and

FIG. 11B are cross-sectional perspective views of the vial devices shown in FIG. 11A taken along a longitudinal axis according to one embodiment.

### DETAILED DESCRIPTION

Various non-limiting embodiments of the present disclosure will now be described to provide an overall understanding of the principles of the structure, function, and use of the vial devices, systems, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

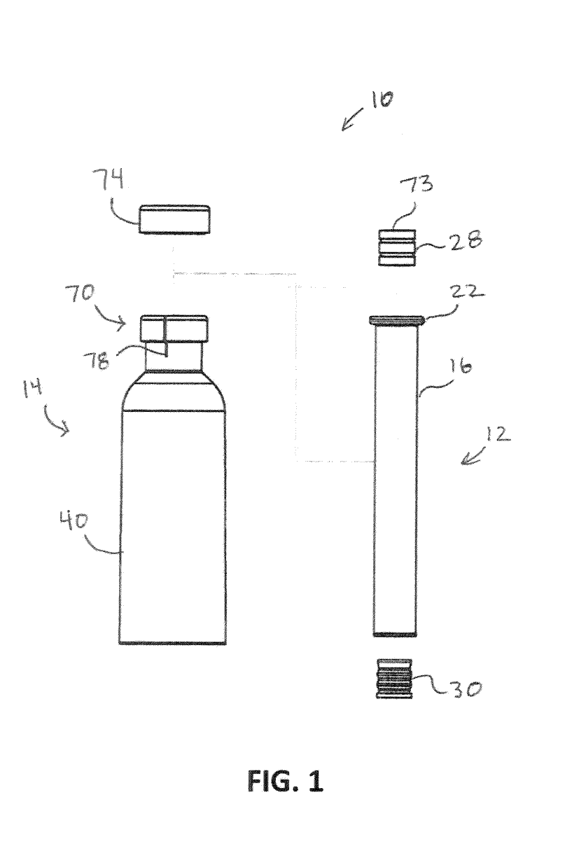

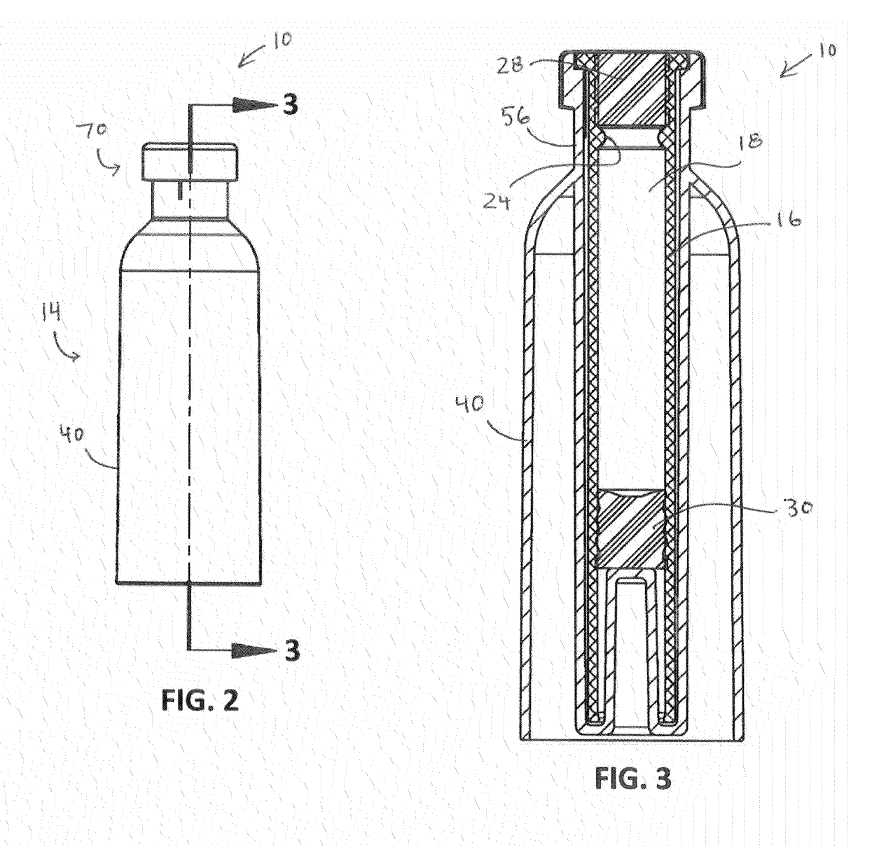

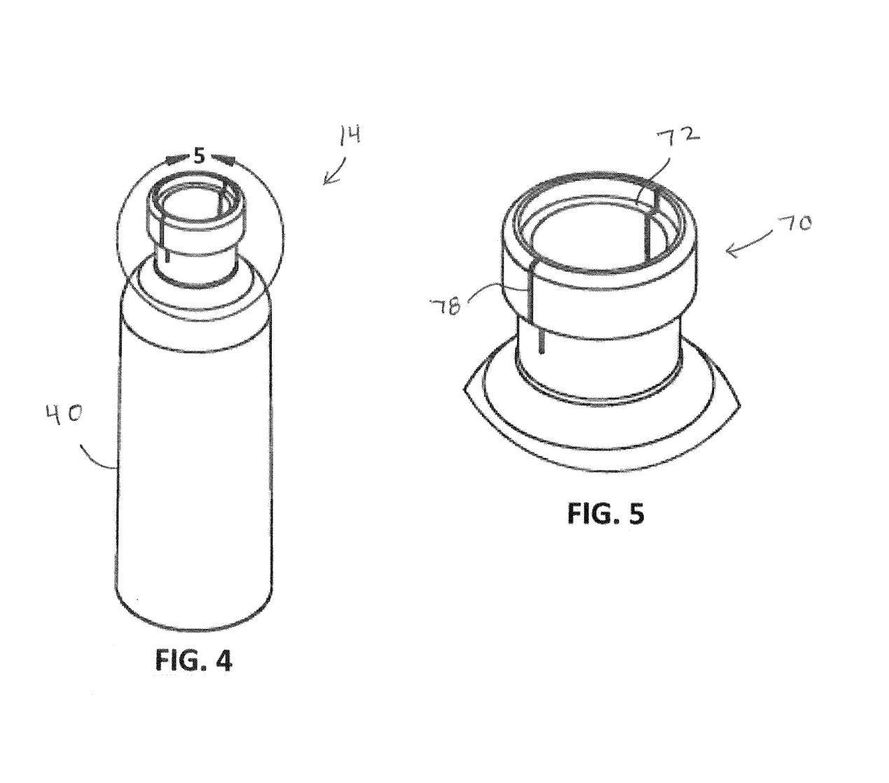

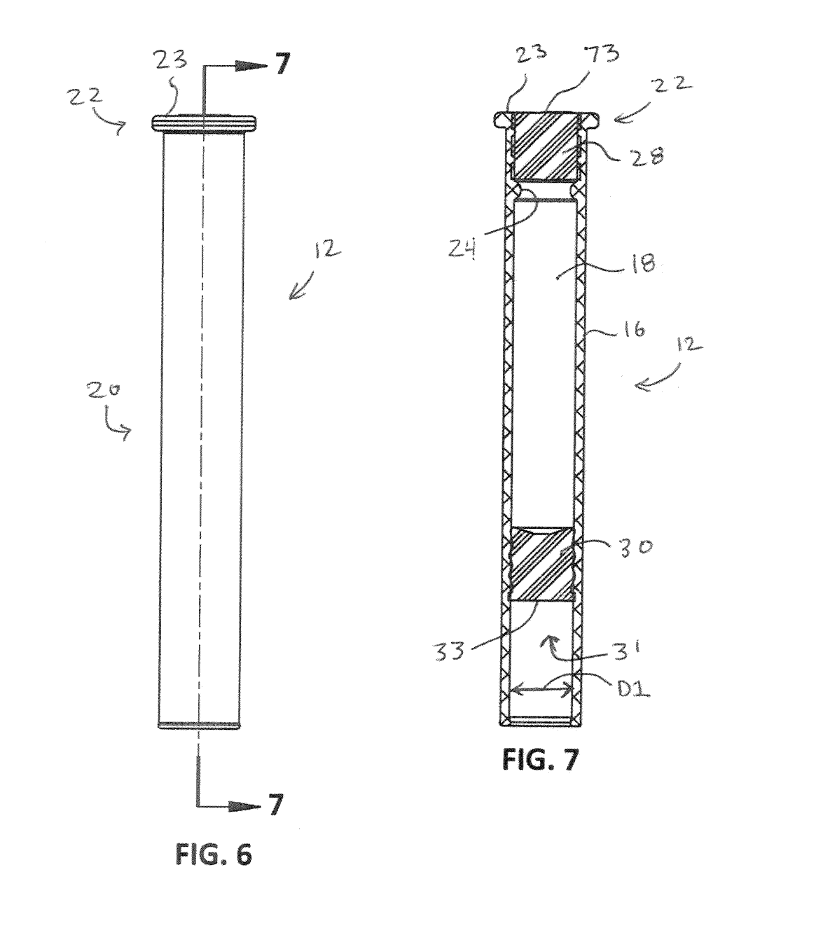

Referring to the drawings, wherein like numbers indicate the same or corresponding elements throughout the views, FIGS. 1-11B illustrate a vial device 10. The vial device 10 can be used to store and dispense fluids, such as medicinal fluids, as subsequently discussed in further detail. The vial device 10 can include a cartridge 12 and an outer housing 14. The cartridge 12 can include a housing 16, which can be hollow and can define a fluid chamber 18, as shown in FIGS. 3 and 7. The housing 16 of cartridge 12 can include a generally cylindrical portion 20 and a proximal flange 22, which can be integral with a proximal end of the generally cylindrical portion 20 of housing 16, as shown in FIG. 6. The proximal flange 22 can have an outer diameter greater than the outer diameter of the generally cylindrical portion 20. The housing 16 of cartridge 12 can be made of glass or plastic, or any other suitable material which can, for example, exhibit a high moisture barrier property. The housing 16 can be clear, opaque, amber, or colored where, for example, the housing 16 can be opaque and can have an amber color, which may be beneficial for use with light-sensitive liquids such as chemotherapy drugs.

As shown in FIG. 1, the cartridge 12 can also include a proximal stopper 28 and a distal stopper 30. The stoppers 28, 30 can be made of a resilient material such as silicone rubber. It is noted that the foregoing materials of construction of housing 16, and stoppers 28, 30 are provided by way of illustration, and not of limitation, as any other suitable material can be used to manufacture the components of cartridge 12.

The proximal stopper 28 can be inserted into the proximal end of the housing 16 of cartridge 12. The housing 16 can have an internal annular ridge 24 (FIG. 7) or shoulder that protrudes into the fluid chamber 18. The annular ridge 24 can help to position the proximal stopper 28 such that a proximal surface 73 can be substantially aligned with a proximal surface 23 of the flange 22. As is to be appreciated, other structural features can be used to facilitate proper placement of the proximal stopper 28. Various securing features or components can be used to secure the proximal stopper 28 to the cartridge 12, such as a crimp ring, for example. The proximal stopper 28 can, for example, be pierced by a needle, a vial adapter, or any other fluid access device or mechanism. In some embodiments, the proximal stopper 28 can be designed for a single use, while other embodiments can include a proximal stopper 28 configured for multiple uses or multiple piercings. The proximal stopper 28 can be self-sealing.

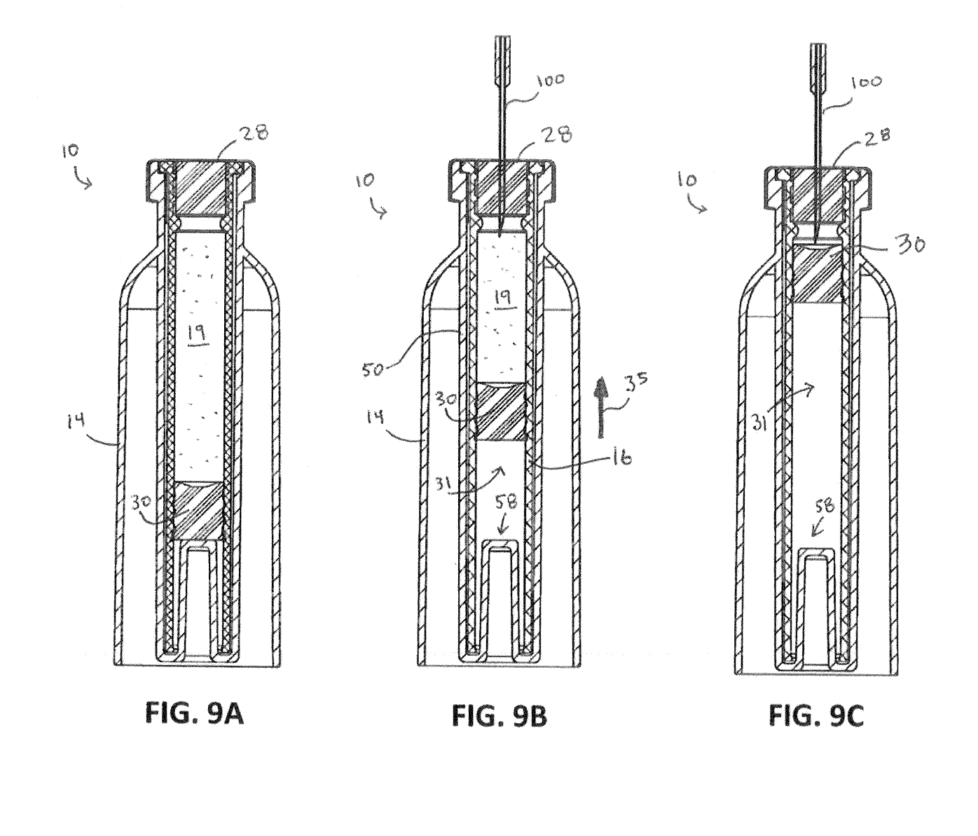

The distal stopper 30 can be positioned within the fluid chamber 18, as shown in FIGS. 3 and 7, for example. The material of stopper 30, which can include silicone rubber, can facilitate sealing the distal stopper 30 against an inside surface of the generally cylindrical portion 20 of housing 16 and can prevent fluid within the fluid chamber 18 from leaking past the distal stopper 30. The distal stopper 30 can be coated with a lubricant, such as silicone, that can facilitate proximal or distal movement of the distal stopper 30 within the housing 16 of the cartridge 12. An example embodiment of the movement of the distal stopper 30 within the housing is described in more detail below with reference to FIGS. 9A-9C.

The housing 16 of cartridge 12 can be sized and configured, in cooperation with the location of distal stopper 30 within housing 16, to contain various volumes of fluids such as, for example, from about 0.5 ml to about 20 ml of fluid, from about 1 ml to about 5 ml of fluid, about 2 ml of fluid, or about 3 ml of fluid. The cartridge 12 can be a pre-filled cartridge, where fluid can be injected into the fluid chamber 18 prior to the connection of the cartridge 12 and outer housing 14. In some embodiments, the fluid chamber 18 can be filled with a relatively minimal amount of headspace such as 2-3% headspace. In other embodiments, a greater amount of headspace, which can include oxygen, air, or other fluid to fill the headspace, can be provided. The distal stopper 30 can be positioned axially at any suitable location within the fluid chamber 18 where, for example, the stopper can have an initial position that defines a desired fluid volume.

The cartridge 12 can have an inner diameter “D1” proximate the distal end (FIG. 7). A cartridge cavity 31 can be defined by the inner wall of housing 16 and the distal surface 33 of the distal stopper 30. The longitudinal length of the cartridge cavity 31 can be determined by the relative longitudinal placement of the distal stopper 30.

Referring now to the outer housing 14, in one embodiment, the outer housing 14 can, for example, be injection molded from clear or opaque resins such as polypropylene (PP), polycarbonate (PC), or can otherwise be manufactured with any suitable material. The outer housing 14 can include an outer body 40, which can be generally cylindrical, or can be any other suitable shape. As shown in FIGS. 1, 3 and 8, the outer housing 14 can be configured such that the cartridge 12 can be positioned within, and surrounded by, the outer housing 14. The outer housing 14 can also include an inner body 50 defining a cavity 52. In some embodiments the cavity 52 can include a circular cross-sectional profile. In some embodiments the cavity can have a square-shaped cross-sectional profile or any other suitable shape, such as a trianglular cross section. The inner body 50 can be coaxial with at least portions of the outer body 40. In some embodiments, the inner body 50 and the outer body 40 can converge (or merge) near the proximal end of the outer housing 14 at annular joint 54 to form a neck portion 56.

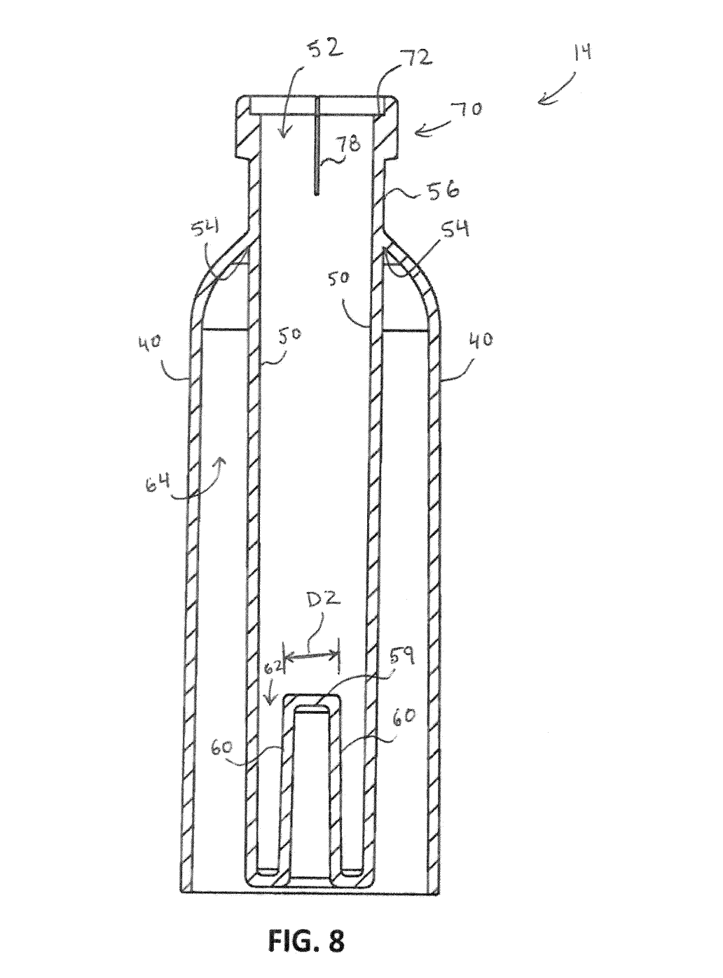

A projection 58 (FIGS. 9B and 9C) can extend into the cavity 52. The projection 58 can be generally cylindrical and can be defined by a projection wall 60 (FIG. 8). The projection wall 60 can be generally coaxial with the inner body 50 such that an annular cavity 62 can be defined intermediate the projection wall 60 and the inner body 50. While the projection 58 is illustrated as being cylindrical, the disclosure is not so limited. In some embodiments, the projection 58 can be conical, frustoconical, or domed, for example. In the illustrated embodiment, the projection can include an outer diameter “D2”, where the outer diameter D2 can be smaller than the inner diameter D1 of cartridge 12 (FIG. 7).

A body cavity 64 (FIG. 8) can be defined by the outer body 40 and the inner body 50. In some embodiments, this cavity can house insulation, coolant, gel, or any other materials that can assist with the regulation of temperature or other parameters. The body cavity can, for example, filled with a filing material during production or can be filled by an end user.

Referring to FIGS. 3 and 8, the vial device 10 can be assembled by mating the cartridge 12 with the outer housing 14. During assembly, the cartridge 12 can be received by the cavity 52 of the outer housing 14. The cartridge 12 can be loaded into the outer housing 14 such that the projection 58 can be received by the cartridge cavity 31 and the distal end of the housing 16 can be received by the annular cavity 62. Depending on the relative placement of the distal stopper 30, the distal surface 33 of the distal stopper 30 can initially rest on the proximal surface 59 (FIG. 8) of the projection 58. The outer housing 14 can have a flange 70 defining an inner shoulder 72 (FIG. 5). The flange 22 of the cartridge 12 can contact the inner shoulder 72 of the outer housing 14 upon insertion. Once the cartridge 12 has been fully seated, a vial closure 74 (FIG. 1) can be attached to the vial device 10.

It is noted that in some embodiments, the outer housing 14 can be opaque, substantially opaque, or can be impervious to certain wavelengths of light. Once the cartridge 12 has been loaded into the outer housing 14, the outer housing 14 can protect the fluid inside the cartridge 12 from exposure to light or certain wavelengths. This protection may be important to various classes of medicament, such as chemotherapy drugs, for example. In an example embodiment, the vial device 10 can require light to pass through a plurality of walls such as the outer body 40, inner body 50, and housing 16 before reaching the medicament, which can limit the damaging effects of light. The outer housing 14 can also protect the cartridge 12 from rupturing or breaking. Any suitable materials can be used to construct the vial device 10. For example, the outer housing 14 can be made from a plastic while the cartridge 12 may be made from glass.

FIGS. 9A-9C show example embodiments of cross-sectional views of a vial device as fluid is progressively withdrawn from the fluid chamber 18. Referring first to FIG. 9A, the cartridge 12 containing a fluid 19 can be positioned within the outer housing 14 or can be produced as an integral component with the outer housing 14. As show in FIG. 9B, a distal tip of a needle 100 can pierce the proximal stopper 28 and can enter the fluid chamber 18. As the fluid 19 is drawn into the needle 100 and into a cavity (not shown) associated with the needle 100, the distal stopper 30 proximally can translate in the direction indicated by arrow 35. As the distal stopper 30 translates within the housing 16, the cartridge cavity 31 can expand. In response, ambient air is introduced to the cartridge cavity via vents 78 (FIGS. 1 and 8). While vents 78 are slits in the illustrated embodiment, this disclosure is not so limited. In other embodiments, bores, grates, or other features may be used to provide ambient air to the cartridge cavity 31 when the distal stopper 30 translates. In the illustrated embodiment, ambient air can enter the vents 78 and can distally travel through the cavity that is intermediate the inner body 50 and the housing 16 until it reaches the distal end of the housing 16. At that point, the ambient air can travel through the cavity that is intermediate the housing 16 and the projection 58 until it reaches the cartridge cavity 31. Referring finally to FIG. 9C, the proximal stopper 30 is shown in its distal position indicating all of the fluid 19 has been withdrawn from the fluid chamber 18.

Since the proximal stopper 30 can be translatable within the housing, the vial device 10 can function as a self-regulating pressurized system. The moving proximal stopper can keep pressure on the system and can assist with the elimination of excess air inside the vial. Additionally, the need to pump ambient air into the vial prior to dispensing the fluid can be eliminated. The movable proximal stopper can put constant pressure on the fluid, which can be beneficial for multi-injection vials, since the movable stopper can allow for multiple injections without increasing or substantially increasing air in the cartridge.

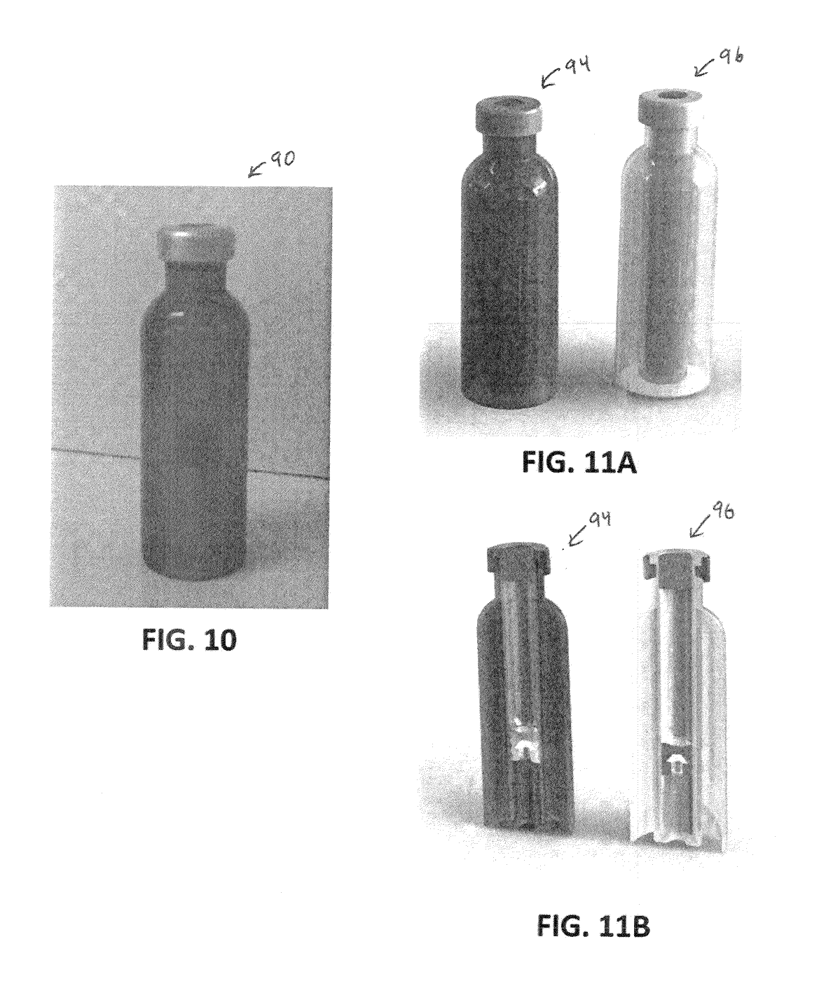

FIGS. 10, 11A and 11B show vial devices in accordance with various non-limiting embodiments. In FIG. 10 a vial device 90 is shown manufactured from an opaque amber material. FIG. 11A shows another embodiment of a vial device 94 manufactured from an opaque material. FIG. 11A also shows a vial device 96 manufactured from a translucent material. FIG. 11B shows cross-sectional views of vial devices 94, 96.

A variety of manufacturing processes can be used to manufacture the vial device. For example, in some embodiments, adhesive can be employed to bond or join components. Adhesives that can be used include, but are not limited to, cynoacrylate, two-part epoxy, heat activated resin, UV cured adhesive, and hot melt. Joining can also be achieved through, but not limited to, the use of solvent bonding, ultrasonics, or heat-staking. Additionally, in some embodiments, single tool molding, ultrasonic welding, or mechanical retention can be utilized to join components of a vial device. Furthermore, where dissimilar materials may be advantageously used, a two-shot or insert molding technique can be utilized.

One or more components of the vial device can be injection molded. This can be achieved such that these components are molded with simple open/closed tooling to reduce tool cost and cycle times. Components of the fluid delivery device can be molded from clear or opaque resins such as polypropylene (PP), polycarbonate (PC), or the like. The cartridge of the vial device can be made of plastic or glass, or other suitable materials that can, for example, exhibit a high moisture barrier property.

The outer body of the vial device can be integrally molded as a unitary structure, or can be molded separately and subsequently joined using any suitable process, including any of the processes described previously.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

What is claimed is:

1. A vial device comprising:
a. a cartridge having a proximal end and a distal end, the cartridge having a housing that defines a fluid chamber;
b. a first stopper, the first stopper being position at about the proximal end of the cartridge;
c. a second stopper, wherein the second stopper is movable relative to the cartridge and is positioned at about the distal end of the cartridge;
d. an opaque outer housing, the cartridge being configured to seat within the opaque outer housing, wherein the cartridge and the opaque outer housing define a cavity therebetween.

2. The vial device of claim 1, wherein the opaque outer housing is amber colored.

3. The vial device of claim 1, wherein the cartridge is configured to retain a light sensitive drug.

4. The vial device of claim 1, wherein the opaque outer housing further comprises a projection, wherein the second stopper is seated on the projection in a first position.

5. The vial device of claim 1, wherein the cavity defined by the cartridge and the opaque outer housing is at least partially filled with a fluid.

6. The vial device of claim 1, wherein the opaque outer housing substantially prevents light from penetrating the cartridge.

7. The vial device of claim 1, wherein the first stopper is configured to be pierced with an injection needle.

8. The vial device of claim 1, wherein the cartridge is a self-regulating pressurized system.

9. A vial device comprising:
a. a cartridge having a proximal end and a distal end, the cartridge having a housing that defines a fluid chamber;
b. a first stopper, the first stopper being position at about the proximal end of the cartridge;
c. a second stopper, wherein the second stopper is movable relative to the cartridge and is positioned at about the distal end of the cartridge;
d. an outer housing, the cartridge being configured to seat within the outer housing, wherein the cartridge and the outer housing define a cavity therebetween.

10. The vial device of claim 9, wherein the outer housing is translucent.

11. The vial device of claim 9, wherein the cartridge is configured to retain a medication.

12. The vial device of claim 9, wherein the outer housing further comprises a projection, wherein the second stopper is seated on the projection in a first position.

13. The vial device of claim 9, wherein the cavity defined by the cartridge and the outer housing is at least partially filled with a fluid.

14. The vial device of claim 9, wherein the outer housing prevents at least one wavelength of light from penetrating the cartridge.

15. The vial device of claim 9, wherein the first stopper is configured to be pieced with an injection needle.

16. The vial device of claim 9, wherein the cartridge is a self-regulating pressurized system.

17. The vial device of claim 9, wherein the outer housing is substantially clear.

18. The vial device of claim 9, wherein the cavity defined by the cartridge and the outer housing is filled with an insulation material.

19. The vial device of claim 9, wherein the cavity defined by the cartridge and the outer housing if filled with an opaque material.

20. The vial device of claim 9, wherein the cartridge and the outer housing are a unitary structure.
